(19) United States
(12) Patent Application Publication
(10) Pub. No.: US 2010/0178450 A1
(43) Pub. Date: Jul. 15, 2010

(54) FOOT MAT

(75) Inventor: Guntmar Seifert, Plauen (DE)

Correspondence Address: MERCHANT & GOULD PC, P.O. BOX 2903, MINNEAPOLIS, MN, 55402-0903, US

(73) Assignee: WINDHAGER HANDELSGESELLSCHAFT M.B.H., Thalgau (AT)

(21) Appl. No.: 12/664,365

(22) PCT Filed: Jun. 11, 2008
(86) PCT No.: PCT/EP2008/004671

§ 371 Date: Dec. 11, 2009

(30) Foreign Application Priority Data
Jun. 13, 2007 (DE) 10 2007 027 228.8

(51) Int. Cl. A47G 27/02; B32B 3/06

(52) U.S. Cl. 428/100

(57) ABSTRACT

A mat is placed in a slip-free manner on carpet that is laid underneath. The mat includes a first side, a second side that is opposite the first side and a plurality of hooking elements for securing the mat to the carpet laid underneath. The hooking elements are arranged at least in a partial area of at least one of the sides.

The invention relates to a mat with integrated hooking elements for securing the mat to the carpet laid underneath.

Mats, which are detachably mountable, are used, for example, to protect the carpet laid underneath against soiling. In so doing, it is often necessary to secure the mats from unintended slipping. At the same time it can be advantageous if the mats can be easily detached from the respective underlying surface for, for example, cleaning purposes.

The task underlying the invention is to create a mat for placing in a slip-free manner on carpet that is laid underneath. A user must be able to easily place said mat on carpet and easily detach it from the same.

The task is solved by the characteristics of claim 1. The quintessence of the invention consists of furnishing the mat with self-catching hooking elements on at least one of its sides. The hooking elements secure the mat in a slip-free manner on carpet that is laid underneath while allowing it to be detached from said carpet at the same time.

Further advantageous configurations of the invention ensue from the sub-claims. Additional characteristics and details of the invention ensue from the description of a plurality of examples of embodiment with the aid of the drawings. The following are shown:

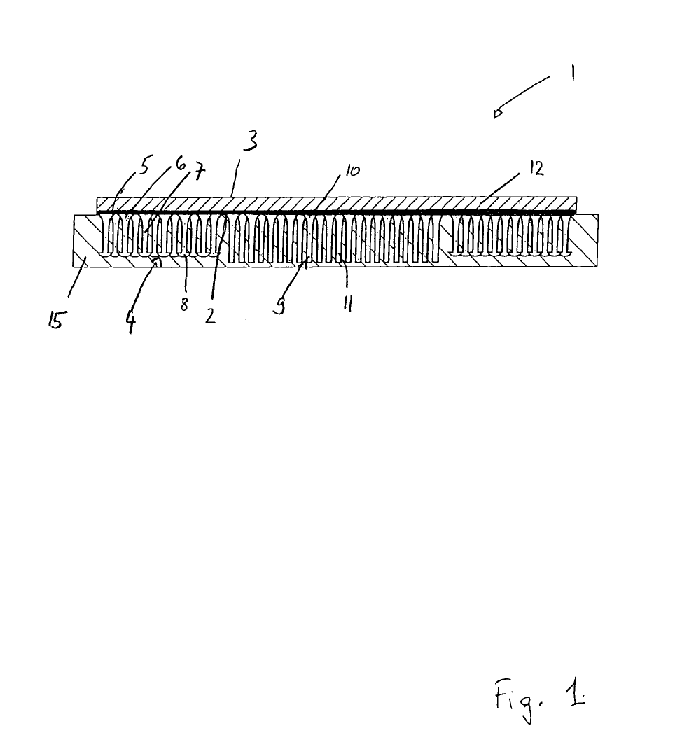

FIG. 1 a cross-section of the mat according to a first example of embodiment,

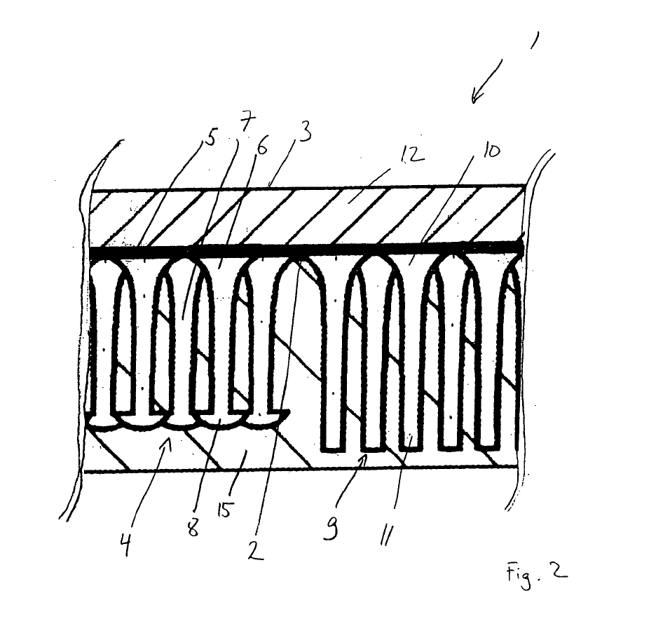

FIG. 2 an enlarged section of the cross-section according to FIG. 1,

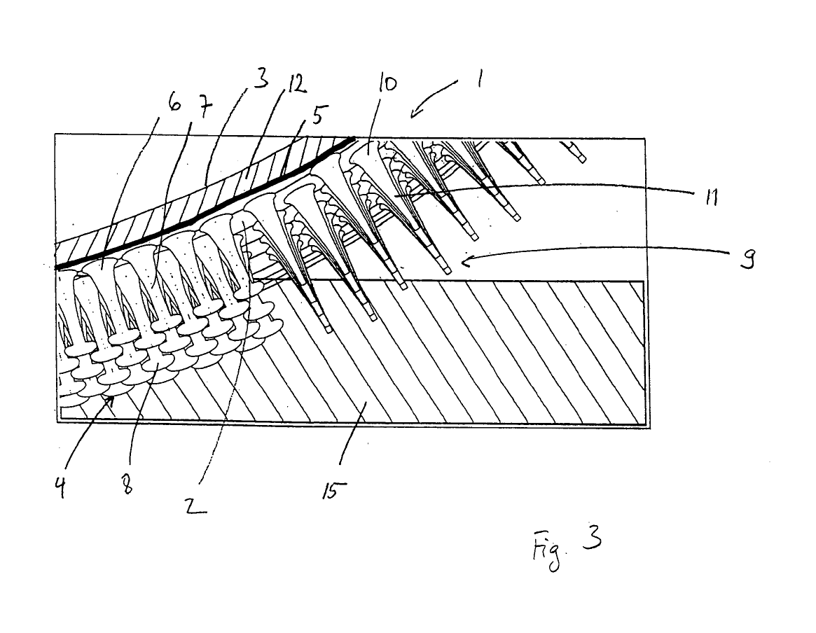

FIG. 3 a bottom view beneath a section of the mat according to FIG. 1 and

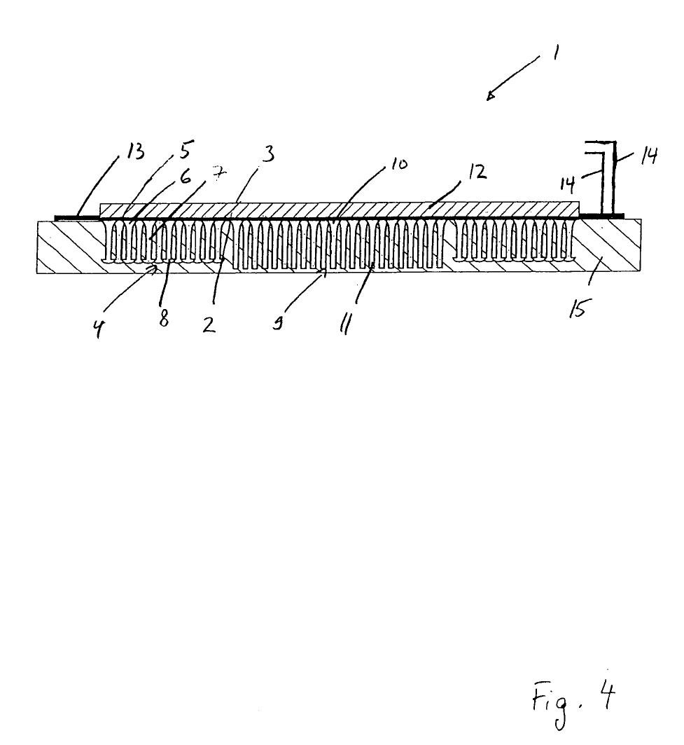

FIG. 4 a cross-sectional view through a mat according to a second example of embodiment.

A first example of embodiment of the invention is described below with reference to FIG. 1. A mat 1 has a matting web 12, which is configured substantially flat, said web 12 having a first side as a bottom side 2 and a second side opposite to this as a top side 3. A plurality of hooking elements 4 is situated on the bottom side 2. Said hooking elements 4 are arranged in a partial area of the bottom side 2. In so doing, the partial area is advantageously situated in the circumferential area of the mat 1. Other arrangements of the hooking elements 4 are likewise possible. In particular hooking elements 4 can also be arranged on the top side 3 of the mat 1. The hooking elements 4 are made from a thermoplastic polymer, in particular from polypropylene. They are configured as one piece with a flat carrier web 5. The hooking elements 4 have a base 6. On the side facing away from the carrier web 5, the base 6 tapers to a stem-like extension 7. The stem-like extensions 7 protrude from the carrier web 5. They are substantially aligned perpendicular to the bottom side 2 of the mat 1. The stem-like extension 7 has a stem head 8 on its end opposite to the base 6. The stem head 8 is configured in such a way that it cooperates in an interlocking manner with fibers, which run transversely to the respective direction of the associated stem-like extension 7. Said stem head 8 therefore forms a positive connection with fibers of this kind. It is configured to radially project from the stem-like extension 7. The stem head 8 is rounded off on its side facing away from the base. The stem head 8 is particularly shaped like a mushroom head. As an alternative to this, the stem head 8 can also be barb-shaped.

According to a first example of embodiment, the mat 1 furthermore has a plurality of anchoring elements 9. The anchoring elements 9 are arranged in a partial area on the bottom side 2 of the mat 1. The anchoring elements 9 and the hooking elements 4 are therefore at least in part arranged on the same side of the mat 1. The partial area, wherein the anchoring elements 9 are arranged, is advantageously situated within the partial area, wherein the hooking elements 4 are arranged. Alternative arrangements of the anchoring elements 9 with reference to the hooking elements 4 are, however, likewise conceivable. The areas with the anchoring elements 9 and with the hooking elements 4 are, for example, arranged so that they overlap in a non-depicted example of embodiment. The anchoring elements 9 are integrally connected to the flat carrier web 5 and protrude from said web 5. The anchoring elements 9 have a base 10. On the side facing away from the carrier web 5, the base 10 tapers to a mandrel-like extension 11. The mandrel-like extensions 11 of the anchoring elements 9 are arranged parallel to each other. The alignment of the anchoring elements 9 is particularly perpendicular to the bottom side 2 of the mat 1. As an alternative to this, provision can likewise be made for the anchoring elements 9 to protrude at a different angle, i.e. obliquely from the bottom side 2 of the mat 1. At least in sections, they are aligned parallel to each other in a certain direction. The anchoring elements 9 have a total length, which is measured from their base 10 on the carrier web 5 up to the outermost end of the respective mandrel-like extension 11, which is advantageously larger than the corresponding length of the hooking elements 4. The anchoring elements 9 are likewise made from a thermoplastic polymer, in particular from polypropylene. The anchoring elements 9 can also be made from a material different from that of the hooking elements 4. The anchoring elements 9 advantageously have a modulus of elasticity higher than that of the hooking elements 4.

The matting web 12 is flexible. It is advantageously elastic. Moreover, it is heat and cold resistant. It is advantageously configured to be stain resistant and washable as well as durable. The flexible carrier web 5 is permanently connected to the matting web 12, for example laminated, welded, glued, sewn, woven or riveted. In a particularly advantageous embodiment, the carrier web 5 is configured as one piece with the matting web 12.

The mat 1 can particularly be secured to a carpet 15 that is laid underneath by means of the anchoring elements 9 and the hooking elements 4. When the mat 1 is placed on carpet 15 that is laid underneath, the hooking elements 4 and the anchoring elements 9 engage with the fibers of said carpet 15. In so doing, the anchoring elements 9 particularly serve to secure the mat 1 in a direction parallel to the upper surface of the mat 1.

By means of the alignment of the anchoring elements 9, a slipping of the mat 1 is prevented. A tendency of said mat 1 to slip in a certain direction can thereby be assisted or else specifically be avoided by means of the alignment of the anchoring elements 9. The hooking elements 4 with their stem heads 8 enter into a hooking engagement with individual fibers of the carpet 15 that is laid underneath. They thereby prevent an unintended lifting of the mat 1 from the carpet 15 laid underneath. The mat 1 is particularly suited to be a floor mat for automobiles.

A further example of embodiment is described below with reference to FIG. 2. Identical parts receive the same reference numerals as was the case in the first example of embodiment, to whose description reference is hereby made. The central difference with respect to the first example of embodiment is that an illumination device 13 is provided at least in sections in the region of the matting web 12. The illumination device 13 is integrated from the top 3 into the matting web 12 as to make said device 13 visible. The illumination device 13 is detachably connected to the mat 1. It can also be permanently connected to the mat 1, for example sewn or glued. It is flexibly designed, in particular foil-like, in the form of a band or a cord. The illumination device 13 is connected via connecting cable 14 to an external power source non-depicted in the figure, for example a car battery. In a further non-depicted embodiment, provision is made for a changeable battery, which is integrated into the mat 1, to serve as the power source. The illumination device 13 is together with the connecting cables 14 configured as a closed, in particular sealed against fluids, and therefore impervious system. The illumination device 13 can be provided in various colors, plain or multi-colored.

Different colorful patterns and effects can be achieved by means of the illumination device 13. For this purpose, a control element, which is not depicted in the figures, is furthermore advantageously provided. In addition to or as an alternative to this, provision can be made for a light sensor, a temperature sensor, a tachometer or another sensor for controlling the illumination device 13. Items of information can also, for example, be situationally indicated in the mat using an illumination device 13 of this kind.

1. Mat for placing in a slip-free manner on carpet, that is laid underneath, comprising:
a) a first side;
b) a second side opposite the first side; and
c) a plurality of hooking elements for securing the mat to the carpet laid underneath,
d) the hooking elements being arranged at least in a partial area of at least one of the sides.

2. Mat according to claim 1, wherein the hooking elements have stem-like extensions with stem heads.

3. Mat according to claim 1, wherein the hooking elements are configured as one piece with a flat carrier web.

4. Mat according to claim 1, wherein the hooking elements are arranged at least in a circumferential partial area of the mat.

5. Mat according to claim 1, further comprising a plurality of anchoring elements having mandrel-like extensions is provided on at least one of the sides.

6. Mat according to claim 5, wherein the anchoring elements are arranged at least in a partial area of at least one of the sides of the mat, the partial area being at least partially surrounded by an area with hooking elements.

7. Mat according to claim 1, wherein the hooking elements and/or the anchoring elements are manufactured from thermoplastic polymer.

8. Mat according to claim 1, wherein an illumination device is integrated in the mat.

9. Mat according to claim 8, wherein the illumination device is detachably connected to the mat.

10. Mat according to claim 8, wherein the illumination device is designed so as to seal out moisture.
